(19) United States
(12) Patent Application Publication
(10) Pub. No.: US 2010/0040850 A1
(43) Pub. Date: Feb. 18, 2010

(54) RESIN COMPOSITION AND DIFFUSION PLATE

(75) Inventors: Yu-Wei CHANG, Taoyuan County (TW); Hung-Han KAO, Taoyuan County (TW); Yu-Chun TAO, Taoyuan County (TW)

Correspondence Address: PATENTTM.US, P. O. BOX 82788, PORTLAND, OR, 97282-0788, US

(73) Assignee: ENTIRE TECHNOLOGY CO., LTD., Taoyuan County (TW)

(21) Appl. No.: 12/534,668

(22) Filed: Aug. 3, 2009

(30) Foreign Application Priority Data
Aug. 12, 2008 (TW) 097130610

(51) Int. Cl. B32B 7/02; B32B 27/32; B32B 27/30; B32B 27/36; B32B 5/16; B29C 47/06; C08L 69/00

(52) U.S. Cl. 428/213; 428/523; 428/522; 428/412; 428/323; 264/173.16; 524/508

(57) ABSTRACT

A resin composition consists of a resin mixture, a light diffusing agent and a fluorescent-whitening agent. The resin mixture consists of 50˜99.9 wt % of polystyrene (PS) and 0.1˜50 wt % of polycarbonate (PC). The light diffusing agent is 0.1˜20 wt % of the resin mixture. The fluorescent-whitening agent is 0.00001˜0.02 wt % of the resin mixture. Therefore, the present invention has low cost because of PS and also possesses high thermal resistance and high impact resistance because of PC. Resin plates made from the resin composition, such as diffusion plates, have improved thermal and impact resistances.

### BACKGROUND OF THE INVENTION

1. Field of Invention

The present invention relates to a resin composition and a diffusion plate, and more particularly to a diffusion plate used for a direct backlight module in a liquid crystal display, the diffusion plate comprises a resin composition with thermal resistance and impact resistance so avoiding softening or damage to the diffusion plate during conveyance of the diffusion plate so improving quality and increases life span.

2. Description of the Related Art

Display industries focus on liquid crystal displays (LCD) due to wide utilization. An electronic field drives the LCD to present an image. However, an LCD array does not omit light, but light is provided from a backlight module. Generally, a direct backlight module is used in large-scale LCDs. Improved brightness and uniform light sources are required for the direct backlight module, which can be achieved by adding light tubes and arranging diffusion elements. Usually, a diffusion assembly is used in the direct backlight module for diffusing light uniformly.

Diffusion assemblies are used for light diffusion. The diffusion assembly may comprise a plurality of diffusion plates made of resin with various light diffusing agents to obtain different refractive indexes. Therefore, light can be refracted many times to make light dispersion uniform.

A conventional diffusion plate comprises a transparent substrate with light diffusion particles to evenly diffuse light and the substrate is made of resin such as transparent poly(methyl methacrylate) (PMMA), PMMA/styrene copolymer (MS) or polycarbonate (PC).

TW 1233935 discloses a resin composition and a molded article including 100 parts by weight of methyl methacrylate resin or styrene resin, 0.1 to 20 parts by weight of a light diffusing agent, 0.0005 to 0.1 parts by weight of a ultraviolet absorber selected from the group consisting of 2-(1-arylalkylidene) malonates and oxalanilides, and 0.0001 to 0.01 parts by weight of a phosphor.

The substrate made by PMMA has an improved optical transmittance and yellowing resistance but it only has 0.3%˜0.4% of water-absorbing rate. Therefore, when used for large-scale displays the substrate may warp and have poor dimensional stability.

The substrate made by PC has excellent thermal resistance, impact resistance and dimensional stability. However, the substrate made by MS or PC has an optical transmittance 2˜3% lower than the substrate made by PMMA and easily yellows under UV illumination. For example, when a PC substrate is illuminated under cold cathode fluorescent-whitening agent lamps (CCFL) for a period, the PC substrate will yellow, which results in problems of color temperature and chromatic aberration. Therefore, the PC substrate can not be broadly used.

Furthermore, a conventional diffusion plate made of PMMA, PMMA/styrene copolymer, PC or the like is not in use anymore because of cost considerations. Recently, polystyrene (PS) is found to have low specific gravity, high dimensional stability and excellent optical properties, so a substrate is made by PC to achieve quality requirements and lower cost. However, mechanical properties and thermal resistance of PS are worse than PMMA and PC. Accordingly, a PS diffusion plate will break during a drop test from different axes, which is conducted for examining resulting LCD products.

Moreover, LCD is required to become brighter and thinner and a distance from CCFLs to the diffusion plate is reduced, but PS cannot endure such high temperature.

Additionally, a conventional method for lengthening life span of a diffusion plate is adding large amounts of UV absorber. However, large amounts of UV absorber allows light transmitted through the diffusion plate or reflected from the diffusion plate to become yellow and negatively impact optical properties.

### SUMMARY OF THE INVENTION

The primary objective of the present invention is to provide a resin composition with improved thermal resistance and impact resistance.

To achieve the objective, the resin composition in accordance with the present invention consists of a resin mixture, a light diffusing agent and a fluorescent-whitening agent. The resin mixture consists of 50˜99.9 wt % of polystyrene (PS) and 0.1˜50 wt % of polycarbonate (PC). The light diffusing agent is 0.1˜20 wt % of the resin mixture. The fluorescent-whitening agent is 0.00001˜0.02 wt % of the resin mixture.

Preferably, the light diffusing agent comprises a plurality of particles with an average particle size of 0.5˜50 micrometers (μm).

Preferably, the light diffusing agent consists of an organic polymer, an inorganic polymer or other material known by a person ordinary skilled in the art, which achieves the same function with the organic polymer or the inorganic polymer.

In another aspect, a diffusion plate is also provided and comprises a resin layer and at least one ultraviolet (UV) absorbing layer. The resin layer consists of a resin composition described above and two opposite surfaces. The UV absorbing layer is applied on at least one surface of the resin layer. The UV absorbing layer consists of 97.9˜99.989 wt % of resin substrate, 0.01˜2 wt % of UV absorber and 0.001˜0.1 wt % of antioxidizing agent. The resin substrate is made of PS, PMMA and PS copolymer (MS), PC or PMMA. The UV absorber may be benzotriazole or benzophenone. The antioxidizing agent may be hindered phenol, phosphite or thioether.

Preferably, the light diffusing agent comprises a plurality of particles with an average particle size of 0.5˜50 micrometers (μm).

Preferably, the light diffusing agent consists of an organic polymer, an inorganic polymer or other material known by a person ordinary skilled in the art, which achieves the same function with the organic polymer or the inorganic polymer.

Preferably, the diffusion plate has a resin layer and an UV absorbing layer. The UV absorbing layer is applied on a surface of the resin layer. A thickness ratio of UV absorbing layer/resin layer is from about 1/99 to 1/2.

Preferably, the diffusion plate has a resin layer and two UV absorbing layers. The UV absorbing layers are respectively applied on two opposite surfaces of the resin layer. A thickness ratio of UV absorbing layer/resin layer/UV absorbing layer is from 0.05/99/0.05 to 1/2/1.

Preferably, the resin layer and the at least one UV absorbing layer are co-extruded to form the diffusion plate.

Therefore, the present invention has low cost because of PS and also possesses high thermal resistance and high impact resistance because of PC. Resin plates made from the resin composition, such as a diffusion plates, have improved thermal and impact resistance.

### DETAILED DESCRIPTION OF THE INVENTION

A resin composition in accordance with the present invention consists of a resin mixture, light diffusing agent and fluorescent-whitening agent.

The resin mixture consists of 50˜99.9 wt % of polystyrene (PS) and 0.1˜50 wt % of polycarbonate (PC). Preferably, the resin mixture is made by melt-blending PS and PC.

The light diffusing agent is 0.1˜20 wt % of the resin mixture. Preferably, the light diffusing agent consists of an organic polymer or an inorganic polymer. The light diffusing agent includes, but is not limited to polystyrene, poly(methyl methacrylate) (PMMA), silicon dioxide (SiO₂), silicone or other polymer known by a person ordinary skilled in the art. The light diffusing agent comprises a plurality of particles with an average particle size of 0.5˜50 micrometers (μm).

The fluorescent-whitening agent is 0.00001˜0.02 wt % of the resin mixture.

A reflective index of PS is 1.59 while a reflective index of PC is also 1.59. Therefore, PS, PC, light diffusing agent and fluorescent-whitening agent are mixed by a mechanical blender, then are melt-blended by a single or double screw extruder to form a resin plate. Because PS and PC have the same reflective index, the resin plate is still transparent. In order to prevent the resin plate from yellowing, the fluorescent-whitening agent is added. Thermal and impact resistances of the resin plate can be adjusted by a proportion of PS and PC. However, if PS is less than 50 wt % of the resin mixture, the cost of the resin plate will be increased. If PS is more than 99.9 wt %, strength and thermal resistance of the resin plate are weak.

The resin composition of the present invention uses melt-blended resin mixture in place of conventional single resin. Therefore, the present invention has low cost because of PS and also possesses high thermal resistance and high impact resistance because of PC (heat distortion temperature is 130˜145° C.). Resin plates made from the resin composition, such as diffusion plates, have improved thermal and impact resistance.

A diffusion plate in accordance with the present invention comprises a resin layer and at least one ultraviolet (UV) absorbing layer.

The resin layer has a resin composition described above and two opposite surfaces. Preferably, the resin layer has a thickness from about 0.6˜6 mm.

The UV absorbing layer is applied on at least one surface of the resin layer. The UV absorbing layer consists of 97.9˜99.989 wt % of resin substrate, 0.01˜2 wt % of UV absorber and 0.001˜0.1 wt % of antioxidizing agent.

The resin substrate is made of PS, PMMA and PS copolymer (MS), PC or PMMA.

The UV absorber may be benzotriazole or benzophenone. A photochemical reaction comprises stages of initiation, transmission, propagation, and termination. Radicals, such as R., ROO., RO. and OH., and hydroperoxides (ROOH) are generated in each stage. Radicals play an important role in this chain reaction. Therefore, the UV absorber is used to eliminate radicals.

The antioxidizing agent may be hindered phenol, phosphite or thioether. The antioxidizing agent is also used to eliminate radicals and further degrades hydroperoxides.

In one aspect, the diffusion plate has a resin layer and an UV absorbing layer. The UV absorbing layer is applied on a surface of the resin layer. The resin layer and the UV absorbing layer are co-extruded to form the diffusion plate. A thickness ratio of UV absorbing layer/resin layer is from about 1/99 to 1/2.

In another aspect, the diffusion plate has a resin layer and two UV absorbing layers. The UV absorbing layers are respectively applied on two opposite surfaces of the resin layer. The resin layer and the UV absorbing layers are co-extruded to form the diffusion plate. A thickness ratio of UV absorbing layer/resin layer/UV absorbing layer is from 0.05/99/0.05 to 1/2/1.

Accordingly, because PC easily yellows under illumination of CCFL, at least one UV absorbing layer is applied on the resin layer to prevent the diffusion plate of the present invention from yellowing. Therefore, the diffusion plate of the present invention has prolonged life span.

### EXAMPLE

1. Effect of Fluorescent-Whitening Agent in Different Proportion of PC and PS in Resin Mixture

A. PS and PC, where a weight ratio of PS/PC was 50/50.

B. PS and PC, where a weight ratio of PS/PC was 80/20.

C. PS and PC, where a weight ratio of PS/PC was 90/10.

0.005 wt % of fluorescent-whitening agent was added in each of the compositions A to C to serve as examples 1 to 3 as shown in table 1.

Single component including composition A, PS or PC without fluorescent-whitening agent respectively serve as comparative example 1 to 3 as shown in table 1.

Compositions of examples 1 to 3 and comparative examples 1 to 3 were respectively mixed by a blender. Then, each of the foregoing resin compositions was melt-blended and extruded to form a resin plate with a thickness of 2 mm.

The resin plates were tested as shown in table 1. ASTM D648 was used for detecting heat distortion temperature (HDT). ASTM D256 was used for detecting Anti-Knock Index (AKI). JIS Z8722 was used for detecting chromaticity in x coordinate (x value) and y coordinate (y value).

TABLE 1
Resin compositions and test results in example 1 to 3 and comparative
example 1 to 3

| | | Fluorescent- | | | | |
|---|---|---|---|---|---|---|
| | Resin | whitening agent | | | x | y |
| | composition | (wt %) | HDT (° C.) | AKI (J/m) | value | value |
| Example 1 | A | 0.005 | 118 | 20 | 0.313 | 0.329 |
| Example 2 | B | 0.005 | 102 | 5.5 | 0.312 | 0.328 |
| Example 3 | C | 0.005 | 97 | 4.85 | 0.312 | 0.328 |
| Comparative | A | — | 118 | 20 | 0.315 | 0.331 |
| example 1 | | | | | | |
| Comparative | PS | — | 91 | 2.91 | 0.313 | 0.329 |
| example 2 | | | | | | |
| Comparative | PC | — | 140 | 50 | 0.313 | 0.329 |
| example 3 | | | | | | |

According to table 1, HDT and AKI of examples 1 to 3 are higher than pure PS resin plate. Compared to example 1 and comparative example 1, chromaticity of the resin plate in example 1 is less than that in comparative example 1. Therefore, fluorescent-whitening agent effectively prevents the resin plate from yellowing. Light reflected or refracted via the resin plate of the present invention will not become yellow.

2. Performance of a Diffusion Plate with Two UV Absorbing Layers

D: PS and PC, where a weight ratio of PS/PC was 80/20.

E-1: siloxane-based copolymers.

E-2: acrylate-based polymer.

F: fluorescent-whitening agent.

G-1: 100 wt % of PMMA-PS copolymer (MS), where a weight ratio of MS/benzotriazole was 99/1.

G-2: 100 wt % of PMMA-PS copolymer (MS), where a weight ratio of MS/benzotriazole was 99.9/0.1).

G-3: 100 wt % of PMMA-PS copolymer (MS), where a weight ratio of MS/benzotriazole/antioxidizing agent was 99.85/0.1/0.05.Examples 4 to 6 and comparative examples 4 to 7 are shown in table 2.

Resin compositions and UV absorbing layer compositions in examples 4 to 6 and comparative examples 4 to 7 were respectively mixed by a blender. Then, each of the foregoing resin composition and UV absorbing compositions were respectively melt-blended and extruded to form a diffusion plate with a thickness of 2 mm. The diffusion plate has a middle resin layer and two exterior UV absorbing layers, wherein a ratio of UV absorbing layer/resin layer/UV absorbing layer is 0.1 mm/1.8 mm/0.1 mm. The diffusion plate was tested as shown in table 3.

Brightness of the diffusion plate was tested by assembling the diffusion plate in a 32″ direct backlight module, which was measured by MB-7 luminance colorimeter.

Durability (□YI, i.e. Yellow Index) of the diffusion plate was tested by using 50 mm*50 mm diffusion plate. The diffusion plate was illuminated continuously by Q-UV panel at 60° C. for 500 hours. Lower □YI indicates that color of the diffusion plate changes less and the diffusion plate has better durability.

TABLE 2
Compositions of resin layer and UV absorbing layer

| | Resin layer | | | | UV absorbing layer | | | |
|---|---|---|---|---|---|---|---|---|
| | Light | | | | | | Light | |
| | diffusing | | Fluorescent- | | | | diffusing | |
| | agent | | whitening agent | | Composition | | agent | |
| | | Conc. | (wt %) | | | Conc. | | Conc. |
| | | (wt %) | | Conc. (wt %) | | (wt %) | | (wt %) |
| Example 4 | E-1 | 1 | F | 0.005 | G-3 | 100 | E-2 | 1 |
| Example 5 | E-1/E-2 | 1/0.5 | F | 0.005 | G-3 | 100 | E-2 | 1 |
| Example 6 | E-2 | 4 | F | 0.005 | G-3 | 100 | E-2 | 1 |
| Comparative | E-1 | 1 | F | 0.005 | — | — | — | — |
| example 4 | | | | | | | | |
| Comparative | E-1/E-2 | 1/0.5 | F | 0.005 | G-1 | 100 | E-2 | 1 |
| example 5 | | | | | | | | |
| Comparative | E-1 | 1 | — | — | G-2 | 100 | E-2 | 1 |
| example 6 | | | | | | | | |
| Comparative | E-2 | 4 | F | 0.005 | G-1 | 100 | — | — |
| example 7 | | | | | | | | |

TABLE 3
Test result of diffusion plates

| | Brightness (cd/m²) | x value | y value | □YI |
|---|---|---|---|---|
| Example 4 | 9950 | 0.313 | 0.325 | 2.2 |
| Example 5 | 9850 | 0.312 | 0.324 | 2.5 |
| Example 6 | 9910 | 0.313 | 0.326 | 2.1 |
| Comparative | 9940 | 0.311 | 0.324 | 10.2 |
| example 4 | | | | |
| Comparative | 9800 | 0.313 | 0.325 | 5.5 |
| example 5 | | | | |
| Comparative | 9800 | 0.315 | 0.328 | 8.8 |
| example 6 | | | | |
| Comparative | 9900 | 0.311 | 0.324 | 5.5 |
| example 7 | | | | |

According to table 3, brightness of the diffusion plates in examples 4 to 6 were better than those in comparative examples 4 to 7. Apparently, the diffusion plates in examples 4 to 6 have better durability than the diffusion plates in comparative examples 4 to 7.

Consequently, the resin composition has improved thermal and impact resistances. Resulting diffusion plate has increased durability and brightness.

What is claimed is:

1. A resin composition consisting of:
a resin mixture consisting of 50˜99.9 wt % of polystyrene (PS) and 0.1˜50 wt % of polycarbonate (PC);
a light diffusing agent being 0.1˜20 wt % of the resin mixture; and
a fluorescent-whitening agent being 0.00001˜0.02 wt % of the resin mixture.

2. The resin composition as claimed in claim 1, wherein the light diffusing agent comprises a plurality of particles with an average particle size of 0.5˜50 micrometers (μm).

3. The resin composition as claimed in claim 1, wherein the light diffusing agent consists of an organic polymer or an inorganic polymer.

4. A diffusion plate, comprising:
a resin layer consisting of:
a resin mixture consisting of 50˜99.9 wt % of polystyrene (PS) and 0.1˜50 wt % of polycarbonate (PC);
a light diffusing agent being 0.1˜20 wt % of the resin mixture; and
a fluorescent-whitening agent being 0.00001˜0.02 wt % of the resin mixture; and
at least one ultraviolet (UV) absorbing layer applied on at least one surface of the resin layer and consisting of 97.9˜99.989 wt % of resin substrate, 0.01˜2 wt % of UV absorber and 0.001˜0.1 wt % of antioxidizing agent,
wherein the resin substrate is selected from the group of PS, poly(methyl methacrylate) (PMMA) and PS copolymer (MS), PC and PMMA;
wherein the UV absorber is selected from the group consisting of benzotriazole and benzophenone; and
wherein the antioxidizing agent is selected from the group consisting of hindered phenol, phosphite and thioether.

5. The diffusion plate as claimed in claim 4, wherein the light diffusing agent comprises a plurality of particles with an average particle size of 0.5˜50 micrometers (μm).

6. The diffusion plate as claimed in claim 4, wherein the light diffusing agent consists of an organic polymer or an inorganic polymer.

7. The diffusion plate as claimed in claim 4, wherein the diffusion plate has a resin layer and one UV absorbing layer applied on a surface of the resin layer and a thickness ratio of UV absorbing layer/resin layer is from 1/99 to 1/2.

8. The diffusion plate as claimed in claim 4, wherein the diffusion plate has a resin layer and two UV absorbing layers respectively applied on two opposite surfaces of the resin layer and a thickness ratio of UV absorbing layer/resin layer/UV absorbing layer is from 0.05/99/0.05 to 1/2/1.

9. The diffusion plate as claimed in claim 7, wherein the resin layer and the UV absorbing layer are co-extruded to form the diffusion plate.

10. The diffusion plate as claimed in claim 8, wherein the resin layer and the UV absorbing layers are co-extruded to form the diffusion plate.
